(19) United States
(12) Patent Application Publication
(10) Pub. No.: US 2022/0205219 A1
(43) Pub. Date: Jun. 30, 2022

(54) WORK VEHICLE

(71) Applicant: KUBOTA CORPORATION, Osaka (JP)

(72) Inventor: Naoya OKAMOTO, Sakai-shi (JP)

(21) Appl. No.: 17/528,229

(22) Filed: Nov. 17, 2021

(30) Foreign Application Priority Data
Dec. 25, 2020 (JP) 2020-216957

(51) Int. Cl. E02F 9/22; E02F 9/20

(52) U.S. Cl. CPC E02F 9/2246; B60Y 2200/41; E02F 9/2012

(57) ABSTRACT

A work vehicle includes a vehicle body provided with an engine, a work device provided for the vehicle body and including an actuator supplied with working fluid from a hydraulic pump drivable by the engine, an acceleration setter to set a rotational speed of the engine, and a control lever to operate a control valve for to control the working fluid from the hydraulic pump. The work vehicle also includes an acceleration adjuster that is located at such a position as to be operable with use of a thumb of a hand on a grip portion of a projecting end of the control lever and that allows the rotational speed of the engine to increase in preference to the setting by the acceleration setter.

### CROSS REFERENCE TO RELATED APPLICATIONS

This application claims the benefit of priority to Japanese Patent Application No. 2020-216957 filed on Dec. 25, 2020. The entire contents of this application are hereby incorporated herein by reference.

### BACKGROUND OF THE INVENTION

### 1. Field of the Invention

The present invention relates to a work vehicle.

### 2. Description of the Related Art

A known work vehicle (see JP H08-21266A, for example) including a front loader that operates via hydraulics provided on a vehicle body can increase the rotational speed of an engine in preference to setting of an accelerator set in advance during operation by the front loader, and can increase the amount of working fluid supplied to the front loader.

In the configuration of JP H08-21266A, a control lever for controlling engine rotation and an operation lever for controlling a work device are disposed near a steering wheel, and a switch for enabling engine rotational speed adjustment is provided on the operation lever. The engine rotational speed can be increased or decreased by operating the switch.

Also, in the configuration described in JP H08-21266A, a hand lever is provided on the operation lever, and the engine speed can be adjusted by operating the hand lever.

### SUMMARY OF THE INVENTION

Regarding a work vehicle provided with a front loader, in a case where work is performed using the front loader with the engine rotational speed preset, there are times when the engine rotational speed needs to be increased. For this reason, as described in JP H08-21266A, there is also a need for a configuration capable of increasing the rotational speed of an engine in preference to a preset rotational speed.

Regarding such an issue, with a configuration in which the control of the engine rotational speed is determined by operation of a switch, slight adjustment of the engine rotational speed is difficult. Also, an electric motor and a control device are required for operating the speed adjustment unit that determines the engine rotational speed. Regarding this issue, the configuration described in JP H08-21266A is a simple configuration in which a hand lever is provided and the engine rotational speed is controlled via a wire.

However, by the hand lever being provided on the operation lever as in JP H08-21266A, a relatively large amount of strength is needed to perform the gripping operation, making continued operation of the operation lever difficult.

For such reasons, there is a demand for a work vehicle that enables engine rotational speed to easily be increased while continuing the required operation.

A work vehicle according to an aspect of a preferred embodiment of the present invention includes a vehicle body provided with an engine; a work device provided for the vehicle body and including an actuator supplied with working fluid from a hydraulic pump drivable by the engine; a control valve to control the working fluid from the hydraulic pump; an acceleration setter to set a rotational speed of the engine; a control lever to operate the control valve; and an acceleration adjuster that is located at such a position as to be operable with use of a thumb of a hand on a grip portion of a projecting end of the control lever, and that allows the rotational speed of the engine to increase in preference to a setting by the acceleration setter.

According to this configuration, in a situation in which the worker holds the grip portion of the control lever and controls the work device, when an increase in the rotational speed of the engine is required, the worker operates the acceleration adjuster with their thumb while holding the grip portion of the control lever. This increases the rotational speed of the engine in preference to the rotational speed of the engine already set by the acceleration adjuster, and allows the amount and pressure of working fluid supplied to the hydraulic actuator of the work device to be increased.

Accordingly, the work vehicle enables the engine rotational speed to easily be increased while continuing the required operation. In particular, with this configuration, because the adjustment amount of the acceleration adjuster can be discretionarily set, slightly adjustment to the rotational speed of the engine is possible.

In addition to the configuration described above, the acceleration adjuster may be operated in a direction that intersects a direction in which the control valve is operated by the control lever.

According to this configuration, the rotational speed of the engine can be increased by operating the acceleration adjuster in a direction perpendicular or substantially perpendicular to the direction the control valve operates via the control lever, and the operation direction of the acceleration adjuster is perpendicular or substantially perpendicular to the operation direction of the control lever. This can help prevent operation errors.

In addition to the configuration described above, the acceleration adjuster may be operated in a direction in which the control lever extends.

According to this configuration, because the acceleration adjuster operates in the direction aligned with the extension direction of the control lever, in a case where a wire to transmit the operation of the acceleration adjuster is used, for example, the wire can be aligned with the extension direction of the control lever. Furthermore, this configuration can also help prevent an operation error of the acceleration adjuster.

In addition to the configuration described above, the configuration may further include a guide body disposed at a lever portion of the control lever and including a linear slide guide extending in the direction in which the acceleration adjuster is operated.

According to this configuration, when the acceleration adjuster is operated in the extension direction of the control lever, the acceleration adjuster can be moved in a straight line due to the slide guide of the guide body guiding the movement of the acceleration adjuster.

In addition to the configuration described above, the acceleration adjuster may include a finger catch portion that allows the acceleration adjuster to be pulled with use of the thumb, and the acceleration adjuster may be provided with an extension portion extending in a direction from the finger catch portion toward the slide guide.

According to this configuration, when the acceleration adjuster is moved by sliding, even if there is resistance via friction on the acceleration adjuster from the slide guide, because the finger catch portion is disposed on an extension line in which the resistance acts, the resistance that acts upon operation does not act in a direction that causes the acceleration adjuster to be inclined, and thus allows for a smooth operation in a straight line.

In addition to the configuration described above, the grip portion may include a bulge portion that bulges out the most with respect to a lever axis of the control lever and a small diameter portion that extends from the bulge portion and is contiguous with a base end side of the control lever and that has a diameter smaller than a diameter of the bulge portion. The acceleration adjuster may include a finger catch portion that allows the acceleration adjuster to be pulled with the use of the thumb, and that is positioned laterally relative to the small diameter portion.

According to this configuration, because the acceleration adjuster is positioned laterally relative to the small diameter portion of the grip portion, when the worker puts the thumb of the grip hand on the finger catch portion and operates the grip portion of the control lever upward, the acceleration adjuster can be operated at a position away from the large diameter portion of the grip portion, causing nothing to impede the operation of the grip portion.

In addition to the configuration described above, the configuration may further include an acceleration adjustment wire including an inner wire that connects at a first end to the acceleration adjuster and connects at a second end to a rotation controller to control the rotational speed of the engine and an outer wire covering the inner wire. The outer wire of the acceleration adjustment wire may include an outer support that is located on a side where the acceleration adjuster is located and that is supported by the control lever, and an inner support to support the inner wire may on a side where the acceleration adjuster is located, wherein an imaginary straight line connecting the inner support with the outer support may be parallel or substantially parallel to a lever axis of the control lever.

According to this configuration, when the acceleration adjuster is operated, the inner wire of the acceleration adjustment wire is pulled in a straight line toward the inner support with respect to the outer support, and the orientation of the inner wire is parallel or substantially parallel to the axis of the control lever. Thus, a large resistance does not act on the inner wire, allowing for smooth operation.

In addition to the configuration described above, the rotation controller may include a speed adjustment arm capable of operating in an acceleration direction to increase the rotational speed of the engine and a deceleration direction to decrease the rotational speed of the engine, a contact portion that is configured to come into contact with the speed adjustment arm in response to the acceleration setter being operated and operate the speed adjustment arm in the acceleration direction, a biasing member to urge the speed adjustment arm in the deceleration direction, a mover that is configured to move in the acceleration direction in response to the inner wire being operated and pulled, and a connector to move the speed adjustment arm in the acceleration direction in response to the mover moving in the acceleration direction, and the connector may include a permitter to permit operation of the speed adjustment arm via operation of the acceleration setter, and move the speed adjustment arm in the acceleration direction in response to the mover moving in the acceleration direction beyond an acceptable range.

According to this configuration, when the speed adjustment arm is operated in the acceleration direction and the deceleration direction by operation of the acceleration setter, regardless of the position of the moving portion by the permitter of the connector, the speed adjustment arm can be operated and the rotational speed of the engine can be set. Also, when the finger catch portion of the acceleration adjuster is pulled and operated and the mover moves beyond the acceptable range of the permitter, the speed adjustment arm can be moved in the acceleration direction, and the rotational speed of the engine can be increased.

In addition to the configuration described above, the configuration may further include a restoring biasing member to, when the acceleration adjuster is in a non-operated state, apply to the inner wire an urging force that pulls back the inner wire.

According to this configuration, in a state in which the finger catch portion is not operated, the finger catch portion can be returned to the non-operation position by the urging force of the restoring biasing member.

In addition to the configuration described above, the configuration may further include an adjuster to adjust an upper limit value of the rotational speed of the engine by restricting the acceleration adjuster.

According to this configuration, a fault that the rotational speed of the engine exceeds the upper limit value restricted by the adjuster can be avoided when the acceleration adjuster is operated.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a tractor.

FIG. 2 is a plan view illustrating the area of the tractor around a driver seat.

FIG. 3 is a partially removed rear view illustrating a control lever and an acceleration adjuster.

FIG. 4 is a cross-sectional view taken along line IV-IV of FIG. 3.

FIG. 5 is a diagram illustrating the connection system of the acceleration adjuster and a rotation controller.

FIG. 6 is a diagram illustrating the rotation controller in a state when the acceleration adjuster is operated.

FIG. 7 is a diagram illustrating an acceleration adjuster of another preferred embodiment (a) of the present invention.

### DETAILED DESCRIPTION OF THE PREFERRED EMBODIMENTS

Preferred embodiments of the present invention will be described below with reference to the drawings.

### Basic Configuration

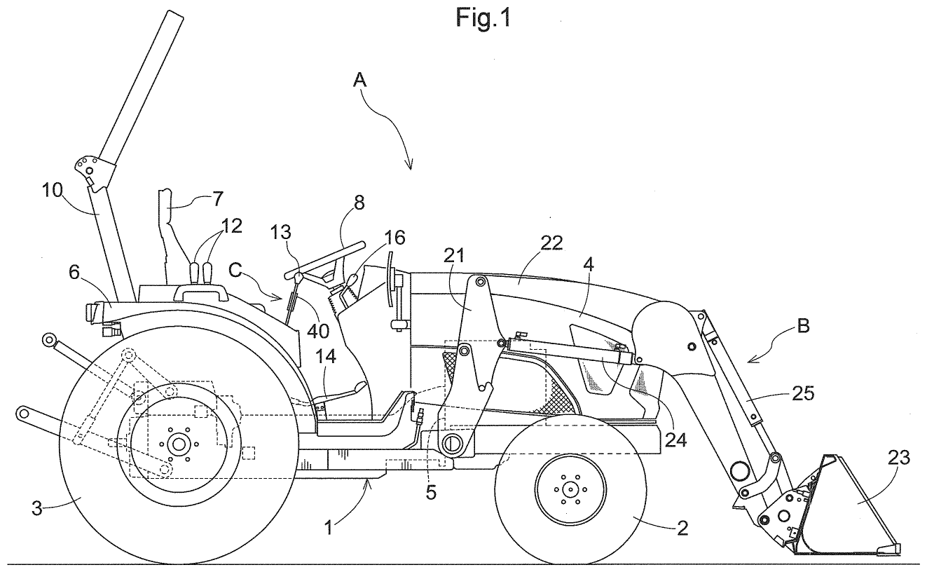

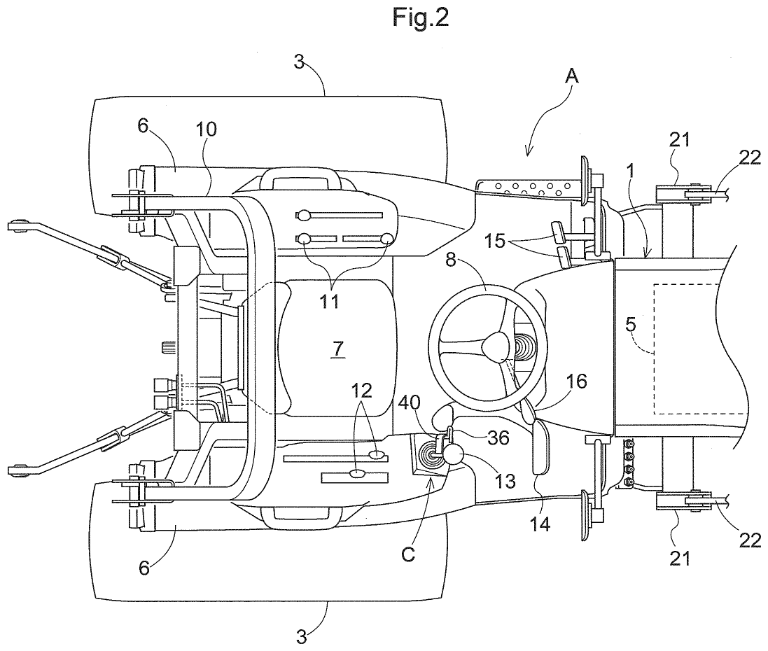

As illustrated in FIGS. 1 and 2, a tractor A, an example of a work vehicle, includes a vehicle body 1 on which a left and right front wheel 2 and a left and right rear wheel 3 are provided. An engine 5 is housed in a bonnet 4 at the front portion of the vehicle body 1, and a driver seat 7 is provided at a position between left and right fenders 6 covering the left and right rear wheel 3. A steering wheel 8 is provided to the front of the driver seat 7, and a front loader B (an example of a work device) is provided at the front portion of the vehicle body 1.

The tractor A (work vehicle) is provided with a rollover protection structure (ROPS) 10 to protect the worker at a rear position of the vehicle body 1, a plurality of first operation levers 11 inserted vertically in a left lever guide are provided on the upper surface of the left fender 6, a plurality of second operation levers 12 inserted vertically in a right lever guide are provided on the right fender 6, and a control lever 13 is provided vertically extending through the right lever guide at a front position of the right lever guide.

Note that in a case where a tilling device or similar soil preparation work device (not illustrated) is provided on the rear end of the vehicle body 1, the plurality of first operation levers 11 and the plurality of second operation levers 12 control the driving of the soil preparation work device, set the tillage level, and the like. The front loader B can be controlled using the control lever 13.

The tractor A is provided with a hydrostatic continuously variable transmission device (not illustrated) capable of changing through a continuous range of speeds of the vehicle body 1, and a shift pedal 14 to control the forward and reverse speed of the vehicle body 1 via control by the continuously variable transmission device is located to the lower right of the driver seat 7. Also, a left and right pair of brake pedals 15 that enable the vehicle body 1 to turn in a small radius via separate control of the left and right rear wheels 3 is located to the lower left of the driver seat 7, and an acceleration setting lever 16 (an example of an acceleration setter) is provided at a position at or near the steering wheel 8.

### Front Loader

The front loader B is provided with a left and right boom capable of freely swinging about a horizontally-orientated support shaft, the left and right boom 22 being supported on a left and right support frame 21 provided on the vehicle body 1; a bucket capable of freely swinging about a horizontally-orientated support shaft, the bucket 23 being provided on the leading end portion of the booms 22; boom cylinders 24 (an example of an actuator) to drive the swinging motion of the booms 22, and bucket cylinders 25 (an example of an actuator) to drive the swinging motion of the bucket 23.

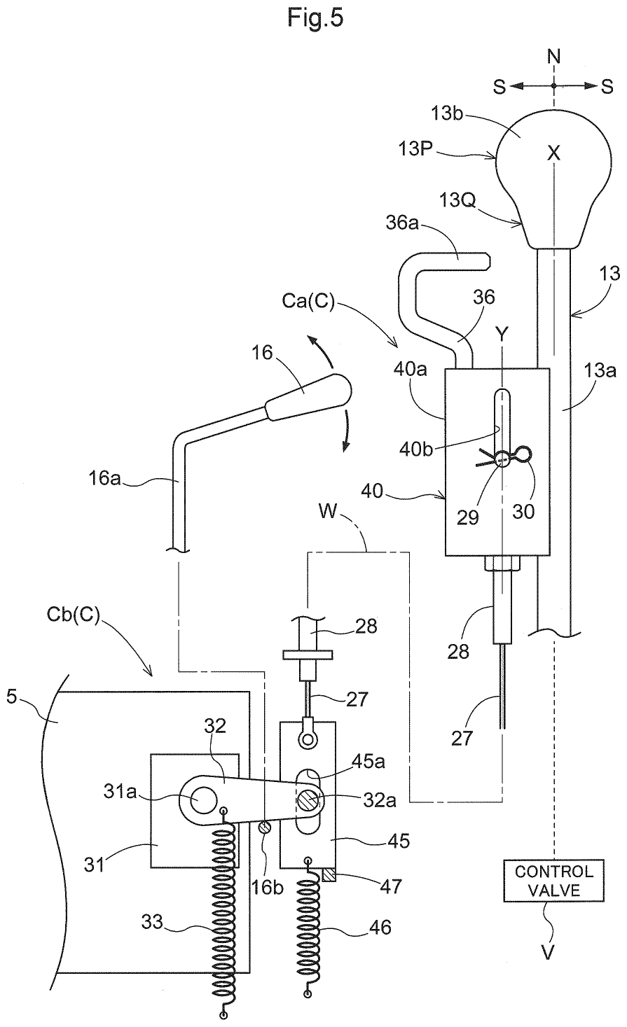

The vehicle body 1 is provided with a hydraulic pump (not illustrated) driven by the engine 5, and the control lever 13 controls a control valve V (see FIG. 5) to supply a working fluid supplied from the hydraulic pump to the boom cylinders 24 and the bucket cylinders 25.

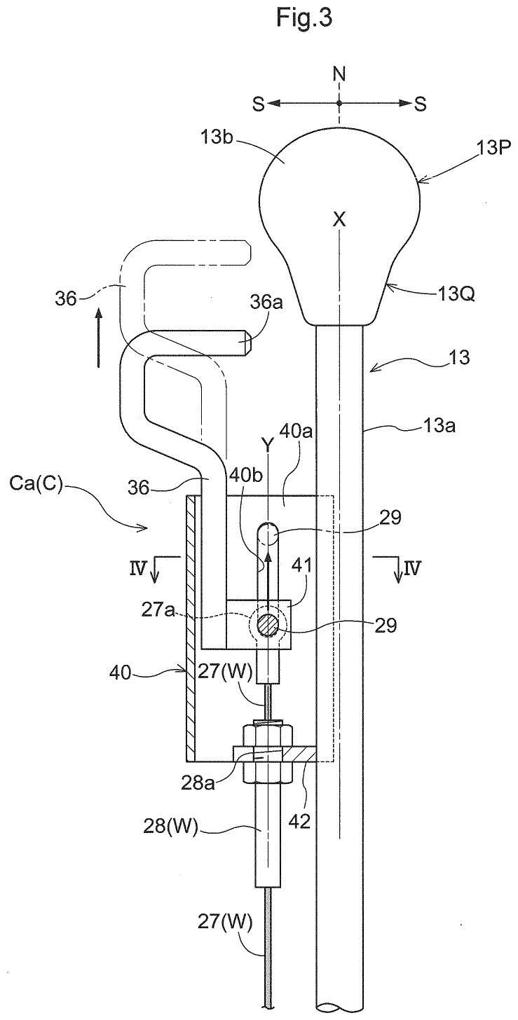

As illustrated in FIGS. 3 to 5, the control lever 13 rests in a neutral orientation N when not operated. By operating the control lever 13 in a left-and-right direction S based on the neutral orientation N, the control valve V operates, causing working fluid to be supplied to the boom cylinders 24, and by operating the control lever 13 in a front-and-back direction T, working fluid is supplied to the bucket cylinders 25. Note that to prevent accidental operation in a case where the front loader B is not used, for example, the control lever 13 can be locked in the neutral orientation N via a predetermined operation.

The acceleration setting lever 16 (acceleration setter) is supported in a manner allowing for the acceleration setting lever 16 to be operated and freely swing in a direction aligned with the front-and-back direction of the vehicle body 1 and is held in a discretionary operation position by friction. As illustrated in FIG. 5, the acceleration setting lever 16 includes a contact portion 16b that moves integrally with the acceleration setting lever 16. When the acceleration setting lever 16 is operated in a swinging motion, the contact portion 16b comes into contact with a speed adjustment arm 32 of a rotation controller 31 and the swing orientation of the speed adjustment arm 32 is set. This maintains the rotational speed (rotational speed per unit time) of the engine 5.

In the tractor A, the control lever 13 is provided with an acceleration adjuster 36 configured to increase the rotational speed of the engine 5 and to increase the amount and the pressure of the working fluid supplied to the boom cylinders 24 and the bucket cylinders 25 by an operation using a thumb without letting go of the control lever 13 in cases where when the worker is performing work with the front loader B by operating the control lever 13 and the work loaded increases.

Note that in the tractor A, the control lever 13 is disposed to the right of the driver seat 7. This allows the worker to operate the acceleration adjuster 36 with the right thumb.

### Acceleration Setting System

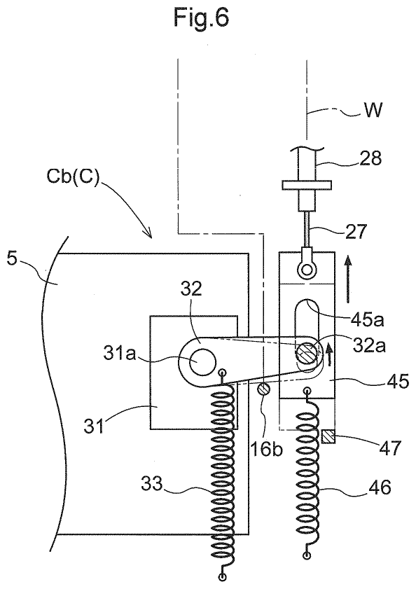

As illustrated in FIGS. 5 and 6, the engine 5 includes the rotation controller 31 to control the rotational speed (rotational speed per unit time) of the engine 5, and the rotation controller 31 is configured or programmed to increase or decrease the rotational speed of the engine 5 via a swinging operation of the speed adjustment arm 32 provided on a speed adjustment shaft 31a.

Also, the speed adjustment arm 32 is freely operatable in an acceleration direction (up in FIGS. 5 and 6) to increase the rotational speed of the engine 5 and a deceleration direction (down in FIGS. 5 and 6) to decrease the rotation of the engine. When the speed adjustment arm 32 is not operated, the urging force of a deceleration spring 33 (an example of a biasing member) that operates in the deceleration direction is active.

Note that hereinafter, in regards to both the acceleration setting lever 16 and the speed adjustment arm 32, the direction of the operation in the direction to increase the rotational speed of the engine 5 is referred to as the “acceleration direction”.

The acceleration setting lever 16 is supported in a manner allowing for the acceleration setting lever 16 to freely swing about a vertically-orientated lever shaft 16a and is held in a swinging operation position by friction. Also, the contact portion 16b is at the lower end portion of the lever shaft 16a, the contact portion 16b being configured to set the rotation angle of the speed adjustment arm 32 in the acceleration direction by coming into contact with the speed adjustment arm 32.

According to this configuration, in a case where the acceleration setting lever 16 is operated in the acceleration direction, the contact by the contact portion 16b swings the speed adjustment arm 32 in the acceleration direction against the urging force of the deceleration spring 33, causing an increase in the rotational speed of the engine 5. Alternatively, in a case where the acceleration setting lever 16 is operated in the deceleration direction, the speed adjustment arm 32 is swung in the deceleration direction by the urging force of the deceleration spring 33, causing a decrease in the rotational speed of the engine 5.

As illustrated in FIGS. 3 to 5, the control lever 13 is provided with a lever portion 13a made of a steel rod material and a grip portion 13b made of resin or the like provided on the projecting end of the lever portion 13a. The base end portion of the lever portion 13a is connected to the control valve V. The acceleration adjuster 36 is disposed near the upper end of the lever portion 13a of the control lever 13.

### Acceleration Adjustment Unit

An acceleration adjustment unit C includes an operation portion Ca including the acceleration adjuster 36 as illustrated in FIGS. 3 and 5, an acceleration adjustment wire W via which the operation force of the acceleration adjuster 36 is transmitted, and a connector Cb capable of increasing the rotational speed of the engine 5 via the operation force transmitted from the acceleration adjustment wire W being transmitted to the speed adjustment arm 32 of the rotation controller 31 as illustrated in FIGS. 5 and 6.

### Acceleration Adjustment Unit: Acceleration Adjuster

As illustrated in FIGS. 3 to 5, the operation portion Ca is provided with the acceleration adjuster 36, a guide body 40 fixed to the lever portion 13a to movably support the acceleration adjuster 36 along the lever portion 13a, a support body 41 fixed to the lower end portion of the acceleration adjuster 36, and a wire fixing plate 42 fixed to the lever portion 13a.

The acceleration adjuster 36 is provided with a finger catch portion 36a on the upper end of the acceleration adjuster 36, the finger catch portion 36a being made of a bend rod material of iron, stainless steel, or the like in manner allowing the worker to put their right thumb on the finger catch portion 36a, and a rod portion of the acceleration adjuster 36 (an example of an extension portion) extending from the finger catch portion 36a in the direction of a guide hole 40b (an example of a slide guide).

By providing the rod portion (extension portion) of the acceleration adjuster 36 with the direction set in this manner, when the acceleration adjuster 36 is operated and pulled, the force acts in a straight line aligned with the rod portion of the acceleration adjuster 36, allowing for smooth operation.

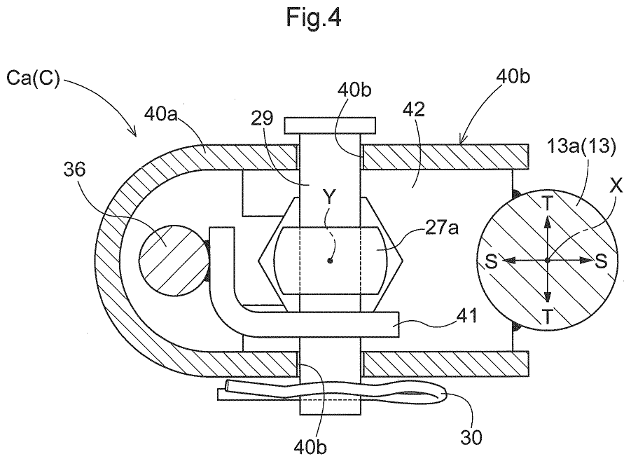

As illustrated in FIG. 4, in the guide body 40, a pair of wall portions 37a in a parallel orientation with one another is formed by bending a plate made of iron, stainless steel, or the like to have a U-shaped cross-sectional shape, with the orientation of the pair of wall portions 37a being set to be parallel to a lever axis X.

As illustrated in FIGS. 3 and 5, the acceleration adjustment wire W is made of an inner wire 27 that connects to the support body 41 and an outer wire 28 that covers the inner wire 27. A first end of the inner wire 27 connects to an inner support 27a, and the inner support 27a and the support body 41 are connected in a manner allowing them to swing freely via a support pin 29 extending therethrough.

As illustrated in FIGS. 3 and 4, the guide hole 40b (slide guide) with a long hole shape extending in a direction parallel or substantially parallel to the lever axis X is provided in a pair of side walls 40a of the guide body 40, and the support pin 29 is inserted into these guide hole 40b. The support pin 29 includes, at one end portion, a head portion and is supported in an undetachable state by a fixing pin 30 being insert at the other end portion of the support pin 29.

Because the support pin 29 is inserted into the guide hole 40b with a long hole shape in this manner, when the acceleration adjuster 36 is operated, the support pin 29 moves in the longitudinal direction of the guide hole 40b, with the motion range of the acceleration adjuster 36 being set to the range within where the support pin 29 comes into contact with both end portions (vertical direction end portions) in the longitudinal direction of the guide hole 40b.

Note that when the acceleration adjuster 36 is not being operated, the support pin 29 comes into contact with the lower end of the guide hole 40b, causing the acceleration adjuster 36 to be held at a non-operation position illustrated in FIG. 5. Also, the position where the support pin 29 comes into contact with the upper end of the guide hole 40b, when the acceleration adjuster 36 is operated by being pulled upward as illustrated by the two-dot chain line in FIG. 3, corresponds to the limiting position of the acceleration direction.

As illustrated in FIG. 3, the wire fixing plate 42 (an example of an outer support) is disposed at a position close to the lower end of the guide body 40 and is fixed via welding to the lever portion 13a of the control lever 13. An outer support 28a located near the upper end portion (the end portion near the acceleration adjuster 36) of the outer wire 28 is supported by the wire fixing plate 42. Note that because the wire fixing plate 42 is connected to the guide body 40, the wire fixing plate 42 together with the guide body 40 are supported by the control lever 13.

Also, an imaginary straight line Y connecting the support position where the inner wire 27 is supported by the support body 41 and the outer support 28a supported by the wire fixing plate 42 is parallel or substantially parallel to the lever axis X. Furthermore, as seen in the direction illustrated in FIG. 3, the imaginary straight line Y overlaps the coupling position of the inner wire 27 with respect to the support body 41 and the outer support 28a of the outer wire 28.

In other words, when the acceleration adjuster 36 is operated and pulled upward, the support pin 29 moves along the guide hole 40b (along the imaginary straight line Y), and this movement causes the inner wire 27 to be operated and pulled at a position with the same axis as the imaginary straight line Y between the support body 41 and the outer support 28a.

As illustrated in FIG. 3, in the operation portion Ca, the grip portion 13b of the control lever 13 includes a bulge portion 13P that bulges out the most with respect to the lever axis X of the lever portion 13a and a small diameter portion 13Q that extends from the bulge portion 13P and is contiguous with the base end side of the control lever 13 and that has a diameter smaller than a diameter of the bulge portion 13P. Also, the finger catch portion 36a of the acceleration adjuster 36 is positioned laterally relative to the small diameter portion 13Q of the grip portion 13b at a position that overlaps the small diameter portion 13Q in a side view orthogonal to the lever axis X.

In the operation portion Ca, the operation direction is set so that when the worker puts their thumb on the finger catch portion 36a of the acceleration adjuster 36 and pulls up, the rotational speed of the engine 5 can be increased. Specifically, the operation direction of the acceleration adjuster corresponds to a direction that intersects any of the operation directions (the left-and-right direction S and the front-and-back direction T) of the control valve V via the control lever 13.

### Acceleration Adjustment Unit: Connection Mechanism

As illustrated in FIGS. 5 and 6, the connector Cb is provided with a mover 45 that slides in the acceleration direction due to a tensile force of the inner wire 27 acting when the acceleration adjuster 36 is operated. The mover 45 is provided with a permitting section 45a including a long hole that permits the operation of the speed adjustment arm 32 caused by operation of the acceleration setting lever 16 (acceleration setter). A contact pin 32a on the leading end portion of the speed adjustment arm 32 is inserted into the permitting section 45a.

The mover 45 has a plate shape, and the inner wire 27 is connected to one end of the mover 45. In a state in which the urging force of a restoring spring 46 (an example of a restoring biasing member) to return the mover 45 is acting and the tensile force is not acting on the inner wire 27, the mover 45 is put into contact via the urging force of the restoring spring 46.

### Operation Mode

With this configuration, when the acceleration setting lever 16 is operated, the contact portion 16b swings while in contact with the speed adjustment arm 32. This causes the speed adjustment arm 32 to be set in a predetermined orientation as illustrated in FIG. 5, setting the rotational speed of the engine 5. When the speed adjustment arm 32 swings in this manner, the contact pin 32a of the speed adjustment arm 32 moves inside the permitting section 45a with a long hole shape.

Also, when the acceleration adjuster 36 is in an unoperated state, the tensile force of the inner wire 27 does not act on the mover 45. Thus, a state in which the mover 45 is put in contact with a stopper 47 via the urging force of the restoring spring 46 is maintained. Also, because the urging force of the restoring spring 46 acts on the support pin 29 via the inner wire 27, the support pin comes into contact with the end portion (end portion on the lower side in FIGS. 3 and 5) on the non-operation side of the guide hole 40b, holding the acceleration adjuster 36 also in the non-operation position illustrated in FIG. 5.

Next, with the rotational speed of the engine 5 set by an operation of the acceleration setting lever 16, when a thumb is placed on the finger catch portion 36a of the acceleration adjuster 36 and the acceleration adjuster 36 is pulled upward, this operation force is transmitted to the mover 45 via the inner wire 27 of the acceleration adjustment wire W.

By the tensile force acting from the inner wire 27 in this manner, the mover 45 moves against the urging force of the restoring spring 46 and the contact pin 32a comes into contact with the end portion of the permitting section 45a with a long hole shape illustrated in FIG. 6. This causes the speed adjustment arm 32 to move in the acceleration direction, increasing the rotational speed of the engine 5. Note that when the acceleration adjuster 36 is operated in the acceleration direction, operation is possible until the support pin 29 described above comes into contact with the upper end of the guide hole 40b.

Also, when the speed adjustment arm 32 swings in the acceleration direction in this manner, the speed adjustment arm 32 swings in a direction away from the contact portion 16b of the acceleration setting lever 16. Thus, the setting position of the acceleration setting lever 16 is not changed.

### Effect of Embodiment

In this manner, in a case where an increase in the rotational speed of the engine 5 is required when performing work using the front loader B, the worker, while holding the grip portion 13b of the control lever 13, can operate the acceleration adjuster with their thumb in the upward direction to increase the rotational speed of the engine 5 in preference to the rotational speed of the engine 5 already set by the acceleration setting lever 16. As a result, the amount and pressure of the working fluid supplied to the boom cylinders 24 and the bucket cylinders 25 of the front loader B is increased, making the work easy to perform without strain.

Also, because the operation direction (upward operation direction) of the acceleration adjuster 36 when the rotational speed of the engine 5 is increased to a direction orthogonal to the operation direction of the control valve V via the control lever 13, operation errors can be eliminated. Also, when the acceleration adjuster 36 is operated and the tensile force acts on the inner wire 27 of the acceleration adjustment wire W, because the imaginary straight line Y connecting the end portion of the inner wire 27 supported by the support body 41 and the support position where the outer wire 28 is supported by the wire fixing plate 42 is aligned with the direction in which the guide hole 40b is provided, the operation can be performed smoothly without resisting the inner wire 27.

The finger catch portion 36a of the acceleration adjuster 36 is positioned laterally relative to the small diameter portion 13Q of the grip portion 13b of the control lever 13. This can prevent a problem such as that caused by the finger catch portion 36a coming into contact with the bulge portion 13P of the grip portion 13b when the worker places their thumb on the finger catch portion 36a and operates the finger catch portion 36a pulling it upward.

The support pin 29 is supported in a manner allowing for free movement in a range in the longitudinal direction of the guide hole 40b of the guide body 40. Thus, the limit of the operation when the acceleration adjuster 36 is operated can be set by the end portion position of the guide hole 40b, allowing excessive operation of the acceleration adjuster 36 to be prevented.

### Other Preferred Embodiments

The present invention may have the configuration described below different from that of the preferred embodiments described above (components with the same function as in the preferred embodiments are given the same number or reference sign as in the preferred embodiments).

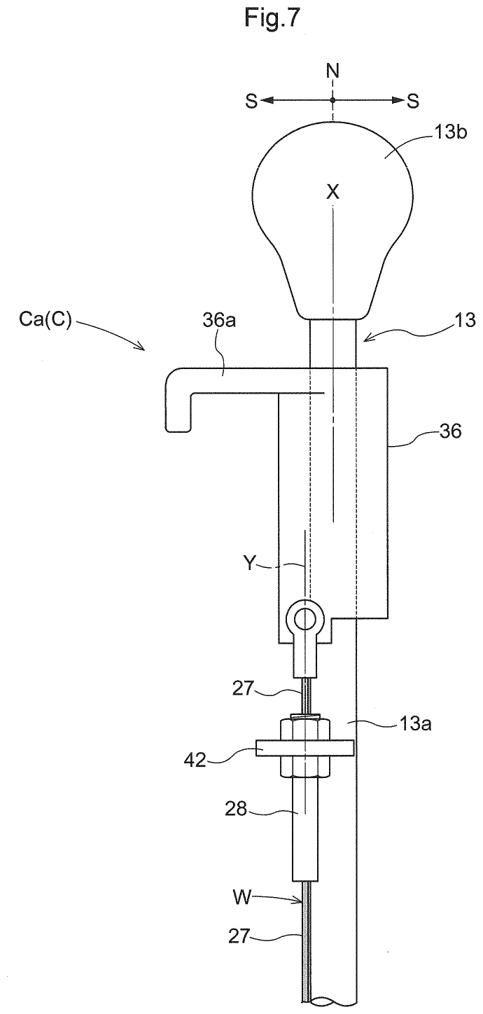

(a) In this configuration, as illustrated in FIG. 7, the acceleration adjuster 36 includes a slide member with a cylindrical shape that fits onto the lever portion 13a of the control lever 13 in a manner allowing it to slide freely. In this other preferred embodiment (a), instead of the rod material described in the preferred embodiments, the acceleration adjuster 36 is constituted by a cylindrical slide member. Also, the inner wire 27 of the acceleration adjustment wire W is supported by the outer surface of the acceleration adjuster 36, the wire fixing plate 42 is fixed to the outer surface of the lever portion 13a, and the inner wire 27 is supported by the acceleration adjuster 36.

In this other preferred embodiment (a), the imaginary straight line Y connecting the support position where the inner wire 27 is supported by the acceleration adjuster 36 and the position on the wire fixing plate 42 where the outer wire 28 is supported can be parallel or substantially parallel to the lever axis X. With such a configuration, the acceleration adjuster 36 is able to be operated in a straight line while in a stable orientation. Also, with this configuration, the connector Cb can have the same configuration as in the preferred embodiments.

(b) In this configuration, the upper limit when the acceleration adjuster 36 is operated can be adjusted. In other words, using a portion of the configuration of the preferred embodiments, a stopper (an example of an adjuster) that comes into contact with the support pin 29 that moves along the guide hole 40b when the acceleration adjuster 36 is operated in the acceleration direction is provided on the guide body 40.

By providing the stopper (adjuster) with a freely adjustable position in this manner, the limit to how much the rotational speed of the engine 5 can be increased when the acceleration adjuster 36 is operated in the acceleration direction can be set.

(c) In a preferred embodiment, the non-operation position is set by the support pin 29 coming into contact with the lower end of the guide hole 40b. In another configuration, instead of this, the lower end portion of the inner support 27a comes into contact with the outer support 28a when the acceleration adjuster 36 is not operated. This allows a non-operation position of the acceleration adjuster 36 to be set.

(d) In this configuration, an operation amount detection unit, such as a potentiometer, a rotary encoder, or the like, to acquire the operation amount when the acceleration adjuster 36 is operated is provided, and the work device is configured to control an actuator to operate the rotation controller 31 of the engine 5 based on the operation amount detected by the operation amount detection unit.

With such a configuration, the acceleration adjustment wire W becomes unnecessary, and movement defects in the mechanically moving portions can be avoided.

Preferred embodiments of the present invention can be applied to work vehicles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle, comprising:
a vehicle body provided with an engine;
a work device provided for the vehicle body and including an actuator supplied with working fluid from a hydraulic pump drivable by the engine;
a control valve to control the working fluid supplied from the hydraulic pump;
an acceleration setter to set a rotational speed of the engine;
a control lever to operate the control valve; and
an acceleration adjuster that is located at such a position as to be operable with use of a thumb of a hand on a grip portion of a projecting end of the control lever and that allows the rotational speed of the engine to increase in preference to the setting by the acceleration setter.

2. The work vehicle according to claim 1, wherein the acceleration adjuster is operated in a direction that intersects a direction in which the control valve is operated by the control lever.

3. The work vehicle according to claim 1, wherein the acceleration adjuster is operated in a direction in which the control lever extends.

4. The work vehicle according to claim 3, further comprising:
a guide body disposed at a lever portion of the control lever and including a linear slide guide extending in the direction in which the acceleration adjuster is operated.

5. The work vehicle according to claim 4, wherein
the acceleration adjuster includes a finger catch portion that allows the acceleration adjuster to be pulled with use of the thumb; and
the acceleration adjuster includes an extension portion extending in a direction from the finger catch portion toward the slide guide.

6. The work vehicle according to claim 1, wherein
the grip portion includes:
a bulge portion that bulges out the most with respect to a lever axis of the control lever; and
a small diameter portion that extends from the bulge portion and is contiguous with a base end side of the control lever and that has a diameter smaller than a diameter of the bulge portion; and
the acceleration adjuster includes a finger catch portion that allows the acceleration adjuster to be pulled with use of the thumb, and that is positioned laterally relative to the small diameter portion.

7. The work vehicle according to claim 1, further comprising:
an acceleration adjustment wire including:
an inner wire that connects at a first end to the acceleration adjuster and connects at a second end to a rotation controller to control the rotational speed of the engine; and
an outer wire covering the inner wire; and
the outer wire of the acceleration adjustment wire includes:
an outer support that is located on a side where the acceleration adjuster is located and that is supported by the control lever; and
an inner support to support the inner wire on a side where the acceleration adjuster is located; wherein
an imaginary straight line connecting the inner support with the outer support is parallel or substantially parallel to a lever axis of the control lever.

8. The work vehicle according to claim 7, wherein
the rotation controller includes:
a speed adjustment arm capable of operating in an acceleration direction to increase the rotational speed of the engine and a deceleration direction to decrease the rotational speed of the engine;
a contact portion that is configured to come into contact with the speed adjustment arm in response to the acceleration setter being operated and operate the speed adjustment arm in the acceleration direction;
a biasing member to urge the speed adjustment arm in the deceleration direction;
a mover that is configured to move in the acceleration direction in response to the inner wire being operated and pulled; and
a connector to move the speed adjustment arm in the acceleration direction in response to the mover moving in the acceleration direction; and
the connector includes a permitter to permit operation of the speed adjustment arm as a result of operation of the acceleration setter, and move the speed adjustment arm in the acceleration direction in response to the mover moving in the acceleration direction beyond an acceptable range.

9. The work vehicle according to claim 8, further comprising:
a restoring biasing member to, when the acceleration adjuster is in a non-operated state, apply to the inner wire an urging force that pulls back the inner wire.

10. The work vehicle according to claim 1, further comprising an adjuster to adjust an upper limit value of the rotational speed of the engine by restricting the acceleration adjuster.
